(19) United States
(12) Patent Application Publication
(10) Pub. No.: US 2011/0157308 A1
(43) Pub. Date: Jun. 30, 2011

(54) THREE-DIMENSIONAL IMAGE REPRODUCING APPARATUS

(75) Inventor: EIJI MANSHO, Osaka (JP)

(73) Assignee: PANASONIC CORPORATION, Osaka (JP)

(21) Appl. No.: 12/975,765

(22) Filed: Dec. 22, 2010

(30) Foreign Application Priority Data
Dec. 28, 2009 (JP) 2009-297432

(51) Int. Cl. H04N 13/00

(52) U.S. Cl. 348/43; 348/E13.003

(57) ABSTRACT

A three-dimensional image reproducing apparatus includes: a data source unit operable to output stream data of 3D contents; a data generating unit operable to output a 3D video signal the 3D contents and an audio signal of the 3D contents on the basis of the stream data; and a data transmission interface including a 2D video signal generating unit operable to generate a predetermined 2D video signal. The data transmission interface is operable to: receive the audio signal of the 3D contents; convert the audio signal of the 3D contents and the predetermined 2D video signal to a signal conforming to a 2D video transmission format; and output the converted signal to an external device.

### BACKGROUND

1. Technical Field

The technical field relates to a three-dimensional image reproducing apparatus for reproducing a stereoscopic image (3D image), and more particularly to a three-dimensional image reproducing apparatus having a plurality of output terminals.

2. Related Art

Hitherto, it is known that a stereoscopic effect can be obtained by presenting images including parallax to a human's right and left eyes (hereinafter called binocular 3D system). One example of such binocular 3D system is described in JP 7-336729 A. Three-dimensional image reproducing apparatuses using this principle have already been put into practical use.

On the other hand, a technology called HDMI (high-definition multimedia interface) is known as an interface for transmitting digital video signals and digital audio signals while protecting copyrights. The HDMI is intended to send out video signals, audio signals, and control signals in a format suited to the specifications of a sink device (a device for receiving data such as a display or an AV amplifier), from a source device (a device for sending out data such as a three-dimensional image reproducing apparatus) to the sink device. For this purpose, prior to the start of transmission of video signals and others, the configuration and the state of the sink device are authenticated by EDID (extended display identification data) by using a DDC (display data channel) signal.

A source device is allowed to transmit a 3D reproduction signal through the HDMI to a sink device in a 3D video transmission format (3D over HDMI) only when the sink device is authenticated to conform to the 3D reproduction signal. Herein, the 3D reproduction signal refers to a signal including a video signal of 3D contents (3D video signal) and an audio signal of the 3D contents. Herein, similarly, a signal including a video signal of 2D contents video signal) and an audio signal of the 2D contents is referred to as a 2D reproduction signal.

More specifically, in order to transmit a 3D reproduction signal (including 3D video and audio for the 3D video) from a source device to a sink device in a 3D video transmission format way of an HDMI cable, the sink device is required to conform to the 3D reproduction signal.

Recently, moreover, a source device (an image reproducing apparatus, etc.) provided with a plurality of systems of HDMI output terminals is also known. For example, in the source device provided with two systems of HDMI output terminals, each one of the HDMI terminals is respectively used as a video transmission output terminal and an audio transmission output terminal, and reproduction with superior sound quality is achieved.

### SUMMARY

Recently, more contents such as movies include multichannel audio as its sound is being made available than ever. Hence, it is often the case that an AV amplifier is used to output sound of the contents so that the effect of the multichanneled audio can be fully enjoyed. Therefore, a three-dimensional image reproducing apparatus is often used while an AV amplifier as well as an image display device is connected thereto.

For example, a conventional three-dimensional image reproducing apparatus provided with a plurality of systems of HDMI output terminals is connected with an image display device conforming to a 3D reproduction signal by way of one of the HDMI terminals and with an AV amplifier not conforming to a 3D reproduction signal by way of another HDMI terminal to make up an AV system.

When 2D contents are reproduced in such an AV system, the three-dimensional image reproducing apparatus outputs 2D reproduction signals to both of the video display apparatus and AV amplifier. Hence, 2D image of the 2D contents is outputted from the video display apparatus and, at the same time, the sound of the 2D contents is outputted from the AV amplifier.

However, in such an AV system, 3D contents cannot be reproduced in the same manner as in the case of the reproduction of 2D contents. This is because, according to the HDMI standard, the three-dimensional image reproducing apparatus cannot send a 3D reproduction signal to an AV amplifier not conforming to the 3D reproduction signal. In other words, from the three-dimensional image reproducing apparatus, a 3D reproduction signal is sent to the image display device, but the 3D reproduction signal is not outputted to the AV amplifier. Accordingly, although a 3D image of the 3D contents can be outputted from the image display device, sound of the 3D contents is not correctly outputted from the AV amplifier.

In short, the problem is that a conventional source device cannot send out the sound of 3D contents correctly unless the sink device conforms to the 3D reproduction signal.

In recognition of the problem in the prior art mentioned above, a three-dimensional reproducing apparatus capable of outputting sound of 3D contents to a sink device not conforming to a 3D reproduction signal is provided according to the embodiments below.

One aspect provides a three-dimensional image reproducing apparatus. The three-dimensional image reproducing apparatus includes: a data source unit operable to output stream data of 3D contents; a data generating unit operable to output a 3D video signal of the 3D contents and an audio signal of the 3D contents on the basis of the stream data; and a data transmission interface including a 2D video signal generating unit operable to generate a predetermined 2D video signal. The data transmission interface is operable to: receive the audio signal of the 3D contents; convert the audio signal of the 3D contents and the predetermined 2D video signal to a signal conforming to a 2D video transmission format; and output the converted signal to an external device.

It is preferable in the one aspect that the three-dimensional image reproducing apparatus further includes a controller operable to control the data transmission interface. The data transmission interface preferably receives both of the audio signal of the 3D contents and the 3D video of the 3D contents from the data generating unit and, when the external device is an audio reproducing device not capable of receiving a signal conforming to a 3D video transmission format, the controller preferably controls the data transmission interface so as to convert the audio signal of the 3D contents and the predetermined 2D video signal to the signal conforming to the 2D video transmission format and output the converted signal, and, when the external device is an device capable of receiving the signal conforming to the 3D video transmission format, the controller preferably controls the data transmission interface so as to convert the audio signal of the 3D contents and the 3D video signal of the 3D contents to the signal conforming to the 3D video transmission format and output the converted signal.

It is preferable in the one aspect that the data transmission interface includes: a changeover circuit operable to receive the predetermined 2D video signal outputted from the 2D video signal generating unit and the 3D video signal outputted from the data generating unit, and selectively output either one of the predetermined 2D video signal and the 3D video signal; and a combining circuit operable to: receive a signal outputted from the changeover circuit and the audio signal of the 3D contents outputted from the data generating unit; combine the audio signal of the 3D contents with the signal outputted from the changeover circuit; and output the combined signal.

It is preferable in the one aspect that the predetermined 2D video signal includes a synchronization signal that can be used for 2D video display in an image display device.

It is preferable in the one aspect that the predetermined 2D video signal includes a video signal which is displayed as a black screen if an image display device performs a 2D image reproduction using the video signal.

It is preferable in the one aspect that the data transmission interface is an HDMI interface.

Another aspect provides a three-dimensional image reproducing method. The method includes: outputting a 3D video signal of 3D contents and an audio signal of the 3D contents on the basis of stream data of the 3D contents; generating a predetermined 2D video signal; and converting the audio signal of the 3D contents and the predetermined 2D video signal to a signal conforming to a 2D video transmission format, and outputting the converted to an external device from a data transmission interface.

### BRIEF DESCRIPTION OF DRAWINGS

FIG. 1 is a schematic diagram of a three-dimensional image reproducing apparatus according to an embodiment and sink devices connected thereto;

FIG. 2 is a block diagram of configuration of the three-dimensional image reproducing apparatus;

FIG. 3 is a block diagram showing the detail of a second data transmission interface;

FIG. 4 is a block diagram of an image display device;

FIG. 5 is a block diagram of an AV amplifier;

FIG. 6 is a flowchart of processing performed by the three-dimensional image reproducing apparatus; and

FIG. 7 is a flowchart of changeover operation related to a changeover switch performed by the three-dimensional image reproducing apparatus.

### DETAILED DESCRIPTION OF PREFERRED EMBODIMENTS

The three-dimensional image reproducing apparatus according to the embodiment is capable outputting an audio of 3D contents to a sink device not conforming to a 3D reproduction signal.

Hereinafter, the embodiment is described in detail.

1. Outline

The embodiment relates to a three-dimensional image reproducing apparatus. The three-dimensional image reproducing apparatus has a plurality of systems of HDMI interfaces (for example, two systems) as output terminals. The three-dimensional image reproducing apparatus can switch the contents of video signals sent out from each of the HDMI interfaces between the video signal of contents being reproduced and a predetermined non-3D video signal and outputs them depending on a combination of 3D video capable/non-capable sink devices connected to the HDMI interfaces.

In that way the three-dimensional image reproducing apparatus of the embodiment may reproduce 3D contents while outputting a 3D video of the 3D contents from a first HDMI interface and, at the same time, outputting an audio signal for the 3D video being combined with a predetermined non-3D video signal from a second HDMI interface in case that the first HDMI interface is connected with a 3D display device conforming to a 3D reproduction signal and the second HDMI interface is connected with an AV amplifier not conforming to a 3D reproduction signal, for example.

Thus, in the embodiment, even in the case where a sink device conforming to a 3D reproduction signal and another sink device not conforming to a 3D reproduction signal are connected to the apparatus at the same time, the 3D image contained in the 3D contents and the sound associated with the 3D image (sound for 3D image) can be sent out to each of the sink devices. Accordingly, when the 3D contents is reproduced by the AV system including: the three-dimensional image reproducing apparatus of the embodiment; the image display device conforming to a 3D reproduction signal; and the AV amplifier not conforming to a 3D reproduction signal, sound for a 3D image of the 3D contents can be outputted from the AV amplifier while displaying the 3D image of the 3D contents on the image display device.

2. Configuration

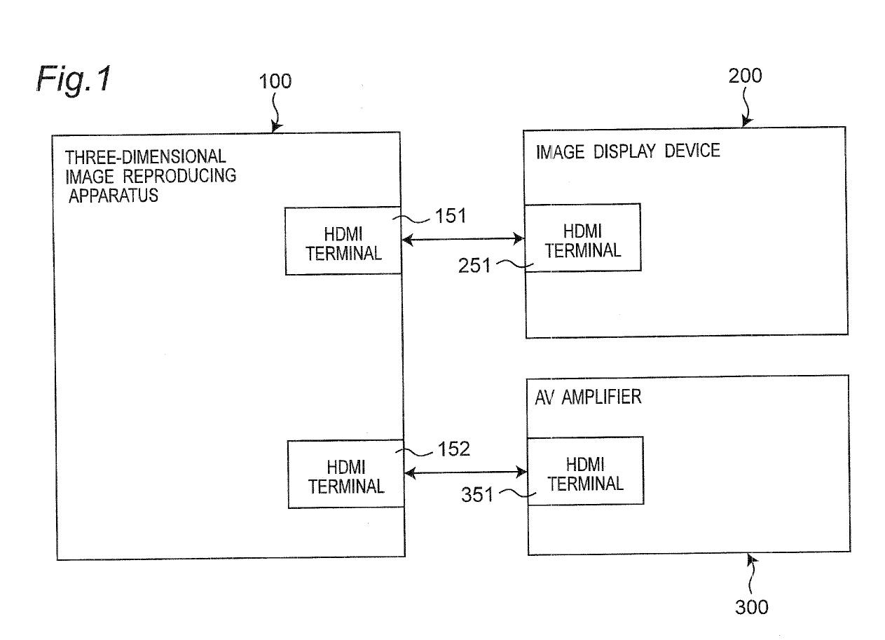

FIG. 1 is a schematic diagram of the AV system including a three-dimensional image reproducing apparatus 100 of the embodiment. The three-dimensional image reproducing apparatus 100 includes a first HDMI terminal 151, and a second HDMI terminal 152. The first HDMI terminal 151 is connected to an HDMI terminal 251 of an image display device 200, and the second HDMI terminal 152 is connected to an HDMI terminal 351 of an AV amplifier 300.

For the connections between the three-dimensional image reproducing apparatus 100 and the image display device 200 and between the three-dimensional image reproducing apparatus 100 and the AV amplifier 300, HDMI cables conforming to the HDMI Ver. 1.4 may be used. In the interface conforming to the HDMI Ver. 1.4, authentication and communication about device information are possible between mutually connected devices, and when the sink device conforms to a 3D reproduction signal, the 3D reproduction signal can be transmitted in a prescribed 3D video transmission format.

In the example shown below, operations of the three-dimensional image reproducing apparatus 100 is explained with the image display device 200 which is an image display device conforming to a 3D reproduction signal. However, the image display device 200 may be an image display device not conforming to a 3D reproduction signal.

Similarly, in the example shown below, the operations of the three-dimensional image reproducing apparatus 100 is explained with the AV amplifier 300 which is an AV amplifier (sound reproducing device) which is capable of neither the reproduction nor the pass-through of a 3D video. However, the AV amplifier 300 may be an AV amplifier (sound reproducing device) being capable of the reproduction and/or the pass-through of a 3D video.

Alternatively, an image display device can be connected to the second HDMI terminal 152 instead of the AV amplifier 300.

The three-dimensional image reproducing apparatus 100 may be also provided with three or more systems of HDMI interfaces.

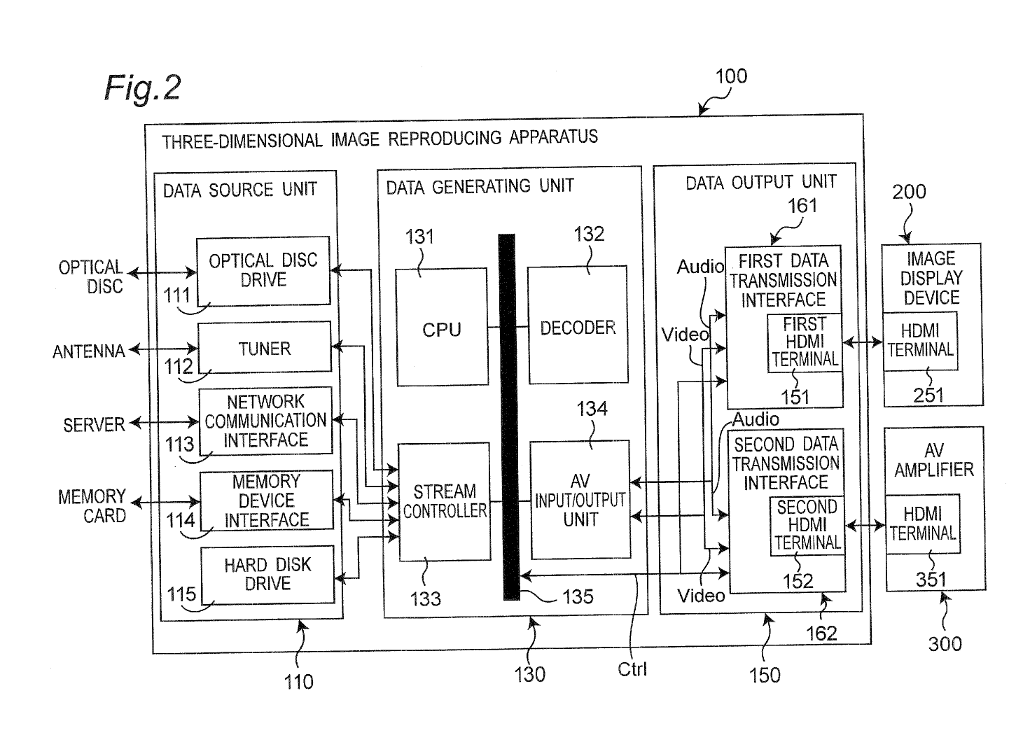

FIG. 2 is a block diagram showing a configuration of the three-dimensional image reproducing apparatus 100.

The three-dimensional image reproducing apparatus 100 includes: a data source unit 110 capable of outputting stream data of the contents to he reproduced; a data generating unit 130 capable of decoding the stream data of the contents; and a data output unit 150 capable of receiving a decoded 3D video signal or a decoded 2D video signal, and a decoded audio signal or a straight stream data of a audio signal, processing, and sending out to a connected external device.

The data source unit 110 includes: an optical disc drive 111 capable of reading out and outputting stream data of 3D/2D contents recorded in an optical disc; a tuner 112 capable of generating and outputting stream data of 3D/2D contents from broadcast waves received by an antenna; a network communication interface 113 capable of receiving stream data of 3D/2D contents by way of a network from a contents server or the like and outputting; a memory device interface 114 capable of receiving stream data of 3D/2D contents from a memory card such as an SD card and outputting; and a hard disk drive 115 capable of storing stream data of 3D/2D contents and outputting appropriately.

The data generating unit 130 can operate as a so-called system controller of the three-dimensional image reproducing apparatus 100.

The data generating unit 130 includes: a stream controller 133 capable of selecting stream data inputted from the data source unit 110; a decoder 132 capable of decoding the stream data selected by the stream controller 133; an AV input/output unit 134 capable of receiving and processing a signal of a 3D video or a 2D video decoded by the decoder 132, and an audio signal decoded by the decoder 132 or stream data of the audio extracted and inputted directly from the stream controller 133, and outputting to the data output unit 150; and a central processing unit 131 (CPU) capable controlling the entire system of the three-dimensional image reproducing apparatus 100. The CPU 131, the decoder 132, the stream controller 133, and the AV input/output unit 134 are connected with each other by data bus 135 so that data can be transmitted and received mutually.

The data output unit 150 has two systems of data transmission interfaces 161 and 162 for sending out a video signal and an audio signal received from the data generating unit 130 to a connected external device(s). The first data transmission interface 161 may be an HDMI interface having the first HDMI terminal 151. The second data transmission interface 162 may be an HDMI interface having the second HDMI terminal 152. The first and second data transmission interfaces 161 and 162 are connected with the CPU 131 by way of the data bus 135 through a control signal line (Ctrl), and the CPU 131 can control the first and second data transmission interfaces 161 and 162.

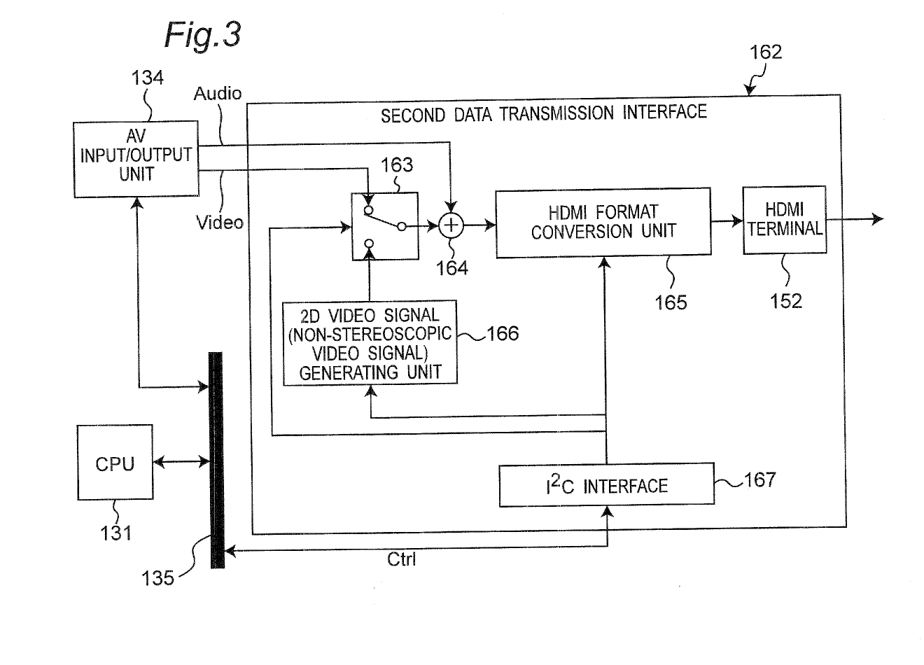

FIG. 3 is a block diagram showing the detail of the second data transmission interface 162. The second data transmission interface 162 has an I²C interface 167, and communicates with the CPU 131 by way of the I²C interface 167. The I²C interface 167 can operate under the control of the CPU 131 by receiving the control signal Ctrl issued from the CPU 131, for example.

The second data transmission interface 162 is capable of receiving an audio signal (Audio) and a video signal (Video) sent from the AV input/output unit 134. As mentioned above, the audio signal (Audio) may be an audio signal decoded by the decoder 132 or stream data directly extracted from the stream controller 133, and the video signal (Video) may be a signal of 3D image or 2D image decoded by the decoder 132.

The audio signal (Audio) is inputted to a combining circuit 164. The combining circuit 164 is a circuit capable of combining the audio signal (Audio) with a signal outputted from the changeover circuit 163.

The video signal (Video) is inputted to one of input terminals of the changeover circuit 163. Herein, the changeover circuit 163 may be a switch circuit having a plurality of input terminals, and one or more output terminals, and capable of selecting an output from the plurality of inputs under the control of the CPU 131.

The output of the 2D video signal generating unit 166 is connected to another input terminal of the changeover circuit 163.

The 2D video signal generating unit 166 can generate and output a predetermined 2D video signal. The predetermined 2D video signal may not be particularly specified as far as it is a 2D video signal, and it is, for example, a synchronization signal (a synchronization signal that can be used in 2D image display) capable of transmitting to a sink device in 2D video transmission format. Alternatively, for example, the predetermined 2D video signal may be, when actually displayed as a 2D image on an image display device, a signal displayed as a black screen (2D black video signal). The 2D black video signal is a signal having an extremely small variation in its signal level, and when the audio signal is sent out as being combined with the same, interference on the audio signal is extremely small. Hence, a quality enhancement effect of audio signal may be expected.

The output terminal of the changeover circuit 163 outputs either one of the video signal (Video) outputted from the AV input/output unit 134 and the predetermined 2D video signal. The signal outputted from the changeover circuit 163 is inputted to the combining circuit 164. The supplied video signal (video signal (Video) or predetermined 2D video signal) is combined with the audio signal (Audio), and inputted to an HDMI format conversion unit 165.

The HDMI format conversion unit 165 may be any HDMI format converting circuit capable of converting a format of an inputted signal to a format conforming to the HDMI Ver. 1.4 standard and outputting. For example, the HDMI format conversion unit 165 converts a format of a signal outputted from the combining circuit 164 into a 3D video transmission format, and outputs as a 3D reproduction signal. Moreover, for example, the HDMI format conversion unit 165 converts a format of a signal outputted from the combining circuit 164 into a 2D video transmission format and outputs as a 2D reproduction signal. Whether the HDMI format conversion unit 165 converts a format of a signal outputted from the combining circuit 164 into a 3D video transmission format or a 2D video transmission format may be determined by the control of the CPU 131.

The second HDMI terminal 152 receives an output from the HDMI format conversion unit 165, and sends out to a connected external device (sink device).

The first data transmission interface 161 may have a similar configuration as that of the second data transmission interface 162. Alternatively, the first data transmission interface 161 may be composed same as the conventional HDMI interface. In the latter case, the first data transmission interface 161 may not have constituents corresponding to the changeover circuit 163, combining circuit 164, and 2D video signal generating unit 166 of the second data transmission interface 162.

The three-dimensional image reproducing apparatus 100 may have three or more systems of data transmission interfaces. In this case, at least one data transmission interface of the three or more systems of data transmission interfaces may have the configuration of the second data transmission interface 162.

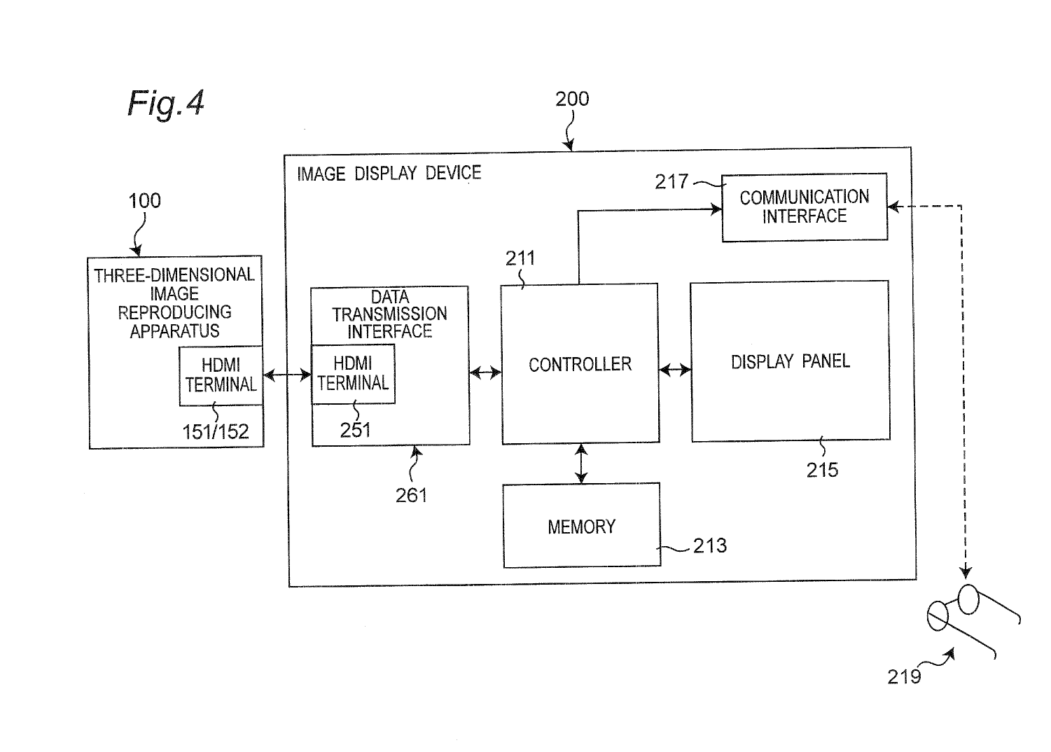

FIG. 4 is a block diagram showing a configuration of the image display device 200. As mentioned above, the image display device 200 may be a 3D display device conforming to a 3D reproduction signal, or a display device not conforming to a 3D reproduction signal. FIG. 4 shows a 3D display device conforming to a 3D reproduction signal as the image display device 200.

The three-dimensional image reproducing apparatus 100 is capable of sending out to the image display device 200 a 3D/2D video signal and an audio signal for the video signal as a 3D reproduction signal/2D reproduction signal in a prescribed format (3D video transmission format/2D video transmission format). The image display device 200 receives the 3D/2D reproduction signal at the HDMI terminal 251 of the data transmission interface 261. The inputted 3D/2D reproduction signal is stored in a memory 213, and is processed by the controller 211. The processed 2D/3D video signal is issued to the display panel 215, and displayed. The controller 211 also outputs to a communication interface 217 a control signal for controlling active shutter eye glasses 219. The active shutter eye glasses 219 receives the control signal through a radio communication with the communication interface 217, and opens and closes the left eye shutter and the right eye shutter. An observer wearing the active shutter eye glasses 219 and observing the display panel 215 therethrough can see an 3D image that has a parallax between the right eye and the left eye.

The image display device 200 may also be equipped with components to output a sound in accordance with the audio signal inputted.

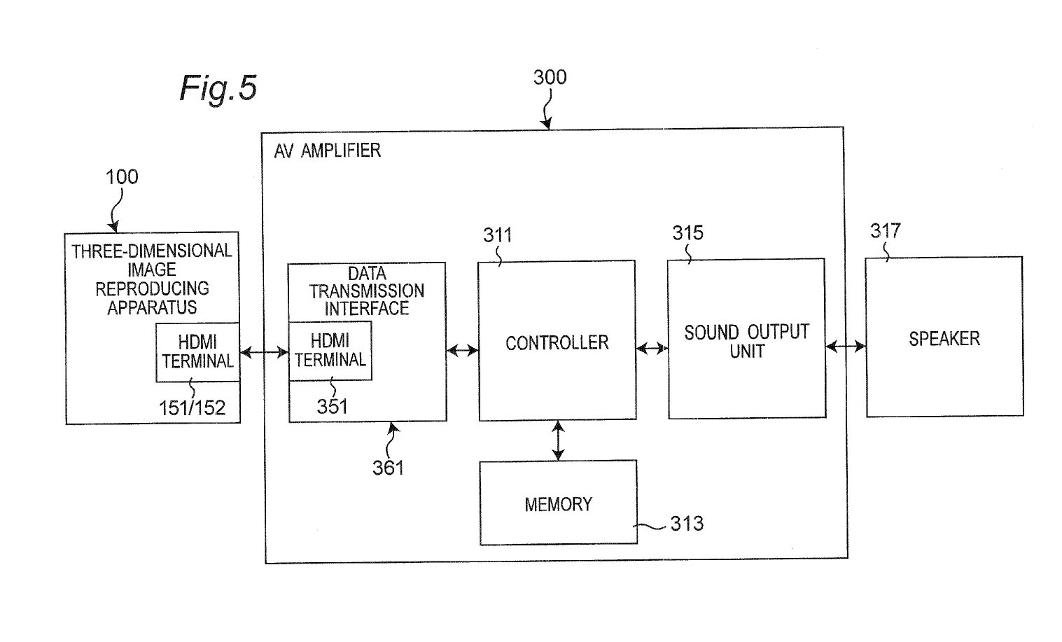

FIG. 5 is a block diagram showing a configuration of the AV amplifier 300. As mentioned above, the AV amplifier 300 may be either an amplifier conforming to a 3D reproduction signal or an amplifier not conforming to a 3D reproduction signal. FIG. 5 shows an AV amplifier not conforming to a 3D reproduction signal as the AV amplifier 300.

As already mentioned, The three-dimensional image reproducing apparatus 100 is capable of transmitting to the AV amplifier 300 a 2D video signal and an audio signal for the 2D video as 2D reproduction signal in a prescribed format (2D video transmission format). The AV amplifier 300 receives the 2D video signal and the audio signal for 2D video at the HDMI terminal 351 of the data transmission interface 361. The inputted 2D video signal and the audio signal are stored in the memory 313, and processed by the controller 311, and only the audio signal is extracted. The controller 311 decodes stream data if the extracted audio signal is stream data, and further converts it to an analog audio signal. If the extracted audio signal is the decoded data, the controller 311 converts the data to an analog audio signal. The controller 311 outputs the analog audio signal to the sound output unit 315. Hence, the sound output unit 315 drives the speaker 317 on the basis of the analog audio signal. Thus sound is outputted from the speaker 317.

3. Operation

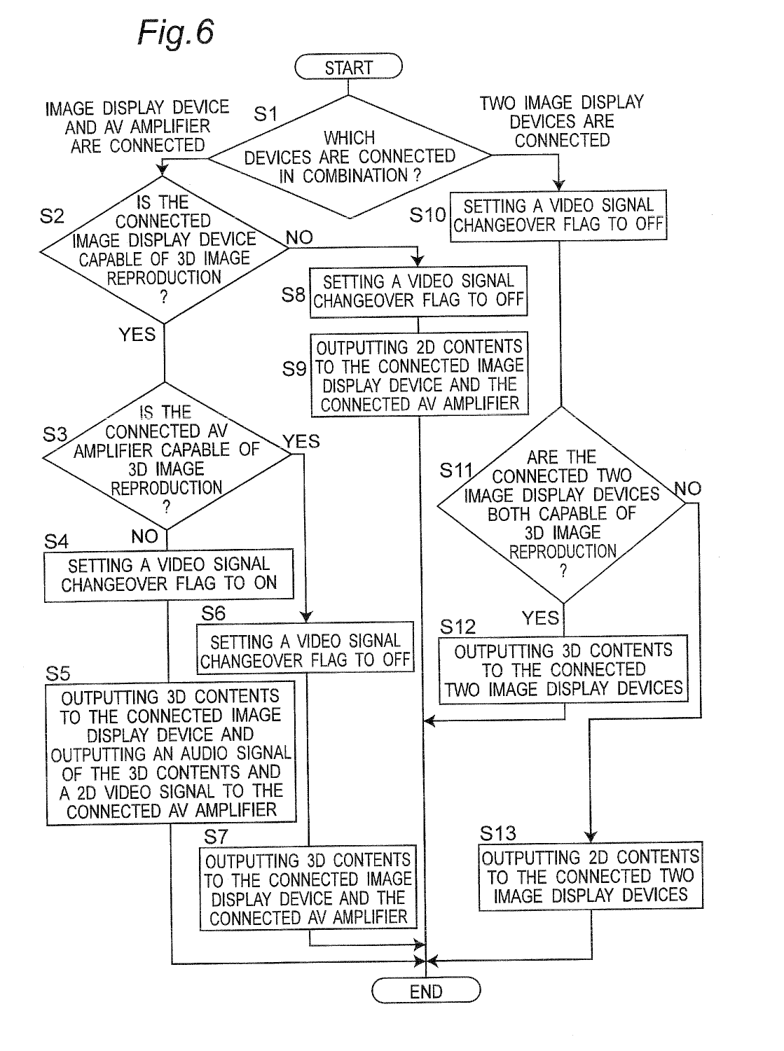

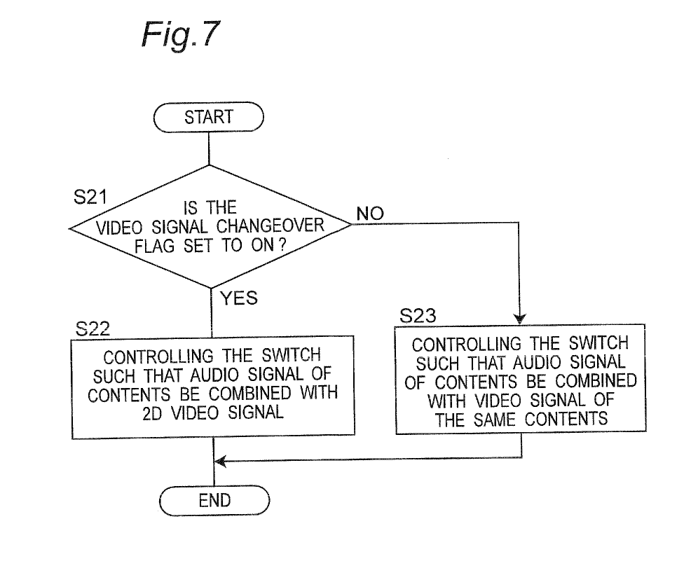

Referring now to FIG. 6 and FIG. 7, operations on the three-dimensional image reproducing apparatus 100 are explained. In the following, processing performed by the three-dimensional image reproducing apparatus 100 for 3D contents reproduction is described. The processing described below may he performed while the CPU 131 reads and executes a program preliminarily installed in the three-dimensional image reproducing apparatus 100. The program may be loaded from a storage medium such as an optical disc and a memory card by the three-dimensional image reproducing apparatus 100, and may be executed by the CPU 131. The program may also he delivered through broadcast waves. The program may also be delivered through a network.

The processing performed by the three-dimensional image reproducing apparatus 100 for 2D contents reproduction (reproduction of contents not requiring a stereoscopic image display) is not explained herein because it is less closely related to the features of the embodiment. However, the three-dimensional image reproducing apparatus 100 can also reproduce the 2D contents.

The three-dimensional image reproducing apparatus 100 has a plurality of systems of data transmission interfaces (two systems in FIG. 2), and can be connected to an image display device, an AV amplifier, and the like via each one of the data transmission interfaces. The apparatus 100 can send out data of contents the connected ones. In the following, the operations are described supposing that the three-dimensional image reproducing apparatus 100 has two systems of data transmission interfaces.

The three-dimensional image reproducing apparatus 100 detects physical connections by its hot-plug function when sink devices are physically connected to the first data transmission interface 161 and second data transmission interface 162, and starts device authentication operations for the connected sink devices. In the device authentication, a source device and a sink device both notify device information of the connected device with each other. By the device authentication operation, the three-dimensional image reproducing apparatus 100 can recognize whether the connected sink device is an image display device or an AV amplifier etc. In addition, the three-dimensional image reproducing apparatus 100 can recognize whether or not the connected sink device conforms to a 3D reproduction signal etc.

The three-dimensional image reproducing apparatus 100 determines, on the basis of the information about the sink device obtained as a result of the device authentication, whether the combination of the sink devices connected to the first and second data transmission interfaces 161 and 162 is an image display device and an AV amplifier, or two image display devices (step S1).

The combination of sink devices may includes a combination of two AV amplifiers and many other combinations, but such combinations are less closely related to the features of the embodiment, and therefore the explanation is omitted. The operations of the three-dimensional image reproducing apparatus 100 when an image display device is connected to the first data transmission interface 161 of the three-dimensional image reproducing apparatus 100 and an image display device or an AV amplifier is connected to the second data transmission interface 162 is described below.

When the combination of the connected sink devices is a combination of an image display device and an AV amplifier, the three-dimensional image reproducing apparatus 100 determines whether the image display device is an image display device capable of 3D image reproduction or not (step S2).

When the connected image display device is an image display device capable of processing a 3D reproduction signal (“Yes” at step S2), the three-dimensional image reproducing apparatus 100 determines whether the connected AV amplifier is an AV amplifier capable of processing a 3D reproduction signal or not (step S3).

When the connected AV amplifier is an AV amplifier which is not capable of processing a 3D reproduction signal (“No” at step S3), the three-dimensional image reproducing apparatus 100 sets a video signal changeover flag, mentioned in detail later, to an ON state (step S4).

FIG. 7 is a flowchart of the process executed by the CPU 131 of the three-dimensional image reproducing apparatus 100 in relation to steps S4 and S6, S8, and S19 mentioned below.

As in the case of step S4, when the video signal changeover flag is set to ON (“Yes” at step S21), the CPU 131 sends to the second data transmission interface 162 an instruction to select an input from the 2D video signal generating unit 166 as the output of a changeover circuit 163. As a result, the predetermined 2D video signal inputted an combining circuit 164 of the second data transmission interface 162, and the predetermined 2D video signal is combined with the audio signal (Audio), and the combined signal is sent to the HDMI format conversion unit 165.

On the other hand, if the video signal changeover flag is set to “OFF” (“No” at step S21), the CPU 131 sends to the second data transmission interface 162 an instruction to select the video signal (Video) inputted from the AV input/output unit 134 as the output of the changeover circuit 163. As a result, the video signal (Video) outputted from the AV input/output unit 134 is inputted to the combining circuit 164 of the second data transmission interface 162, and the video signal (Video) is combined with the audio signal (Audio), and the combined signal is sent to the HDMI format conversion unit 165.

Referring to FIG. 6 again, at step S5, the three-dimensional image reproducing apparatus 100 sends 3D contents out. More specifically, the decoder 132 decodes the stream data of the 3D contents as a 3D video, and the decoded 3D video of the 3D contents and a decoded audio signal of the 3D contents (the audio signal may be stream data) are outputted to the AV input/output unit 134. The AV input/output unit 134 sends the 3D video of the 3D contents and the audio signal of the 3D contents to both of the first data transmission interface 161 and the second data transmission interface 162.

The first data transmission interface 161 sends out to the connected image display device the 3D video of the 3D contents and the audio signal of the 3D contents as a 3D reproduction signal in the 3D video transmission format.

In the second data transmission interface 162, the changeover circuit 163 is controlled so that the input from the 2D video signal generating unit 166 may be outputted to the combining circuit 164. Accordingly, the second data transmission interface 162 sends out to the connected AV amplifier the predetermined 2D video signal and the audio signal of she 3D contents as a 2D reproduction signal in the 2D video transmission format.

On the other hand, when the connected AV amplifier is an AV amplifier capable of processing a 3D reproduction signal (“Yes” at step S3), the three-dimensional image reproducing apparatus 100 set the video signal changeover flag to “OFF” (step S6).

When the video signal changeover flag is set to “OFF” as in the case of step S6, the CPU 131 sends to the second data transmission interface 162 an instruction to select the input from the AV input/output unit 134 as the output of the changeover circuit 163. As a result, the video signal (Video) outputted from the AV input/output unit 134 is inputted to the combining circuit 164 of the second data transmission interface 162, and the video signal (Video) is combined with the audio signal (Audio), and the combined signal is sent to the HDMI format conversion unit 165.

The first data transmission interface 161 sends out to the connected image display device the 3D video of the 3D contents and the audio signal of the 3D contents as a 3D reproduction signal in the 3D video transmission format. The second data transmission interface 162 sends out to the connected AV amplifier the 3D video of the 3D contents and the audio signal of the 3D contents as a 3D reproduction signal in the 3D video transmission format (step S7).

Contrary, at step S2, when the connected image display device is determined to be an image display device which is not capable of processing a 3D image reproduction signal (“No” at step S2), the three-dimensional image reproducing apparatus 100 set the video signal changeover flag to “OFF” (step S8).

Consequently, the three-dimensional image reproducing apparatus 100 sends the contents that contain no 3D images out. More specifically, the decoder 132 decodes the stream data of the contents as a 2D video, and the decoded 2D video of the contents and a decoded audio signal of the contents (the audio signal may be stream data) are outputted to the AV input/output unit 134. The AV input/output unit 134 sends the 2D video of the contents and the audio signal of the contents to both of the first data transmission interface 161 and the second data transmission interface 162. The first data transmission interface 161 and the second data transmission interface 162 send out to the connected image display device and the connected AV amplifier the 2D video signal of the contents and the audio signal of the contents as a 2D reproduction signal in the 2D video transmission format (step S9).

Next, at step S1, when the combination of the connected sink devices is determined to be a combination of two image display devices, the three-dimensional image reproducing apparatus 100 sets the video signal changeover flag to “OFF” (step S10).

Next, the three-dimensional image reproducing apparatus 100 determines whether both of the two connected image display devices are image display devices capable of processing a 3D reproduction signal or not (step S11).

When the connected two image display devices are image display devices capable of processing a 3D reproduction signal (“Yes” at S11), the three-dimensional image reproducing apparatus 100 sends 3D contents out. More specifically, the decoder 132 decodes the stream data of the 3D contents as a 3D video, and the decoded 3D video of the 3D contents and a decoded audio signal of the 3D contents (the audio signal may be stream data) are outputted to the AV input/output unit 134. The AV input/output unit 134 sends the 3D video of the 3D contents and the audio signal of the 3D contents to both of the first data transmission interface 161 and the second data transmission interface 162. The first data transmission interface 161 and the second data transmission interface 162 send out to the connected two image display devices the 3D video of the 3D contents and the audio signal of the 3D contents as a 3D reproduction signal in the 3D video transmission format (step S12).

On the other hand, when at least one of the connected two image display devices is determined to he an image display device which is not capable of processing a 3D reproduction signal (“No” at S11), the three-dimensional image reproducing apparatus 100 sends the contents that contain no 3D images out. More specifically, the decoder 132 decodes the stream data of the contents as 2D video, and the decoded 2D video of the contents and a decoded audio signal of the contents (the audio signal may be stream data) are outputted to the AV input/output unit 134. The AV input/output unit 134 sends the 2D video of the contents and the audio signal of the contents to both of the first data transmission interface 161 and the second data transmission interface 162. The first data transmission interface 161 and the second data transmission interface 162 send out to the connected two image display devices the 2D video signal of the contents and the audio signal of the contents as a 2D reproduction signal in the 2D video transmission format (step S13).

4. Summary

As described herein, the three-dimensional image reproducing apparatus 100 includes a plurality of systems of data transmission interfaces, and, according to the specifications of a plurality of sink devices connected to the data transmission interfaces, can select a video signal to be sent out from each of the data transmission interface and a transmission format to be used in the transmission. Thus, in the AV system in which the image display device conforming to the 3D video and the AV amplifier not conforming to the 3D video are connected to the three-dimensional image reproducing apparatus 100, the 3D video can be sent out to the image display device as a 3D reproduction signal and, at the same time, the audio for the 3D video can be sent out to the AV amplifier as a 2D reproduction signal. Accordingly, a user can play back the sound of the 3D contents with the AV amplifier not conforming to a 3D video at high sound quality while appreciating the 3D image with the image display device conforming to a 3D video. In other words, even when an AV amplifier which is not capable of reproduction and pass-through of a 3D video is connected at one of the systems of the data transmission interfaces, the three-dimensional image reproducing apparatus 100 can reproduce 3D contents as far as the image display device connected is capable of a 3D video reproduction.

It is to be noted that the data transmission interface of the three-dimensional image reproducing apparatus 100 is not limited to an HDMI interface.

It is also to be noted that, as for the audio signal, whether the decoder unit 132 may decode the stream data or the stream data may be sent to the sink device directly may be selected as desired depending on the setting of the three-dimensional image reproducing apparatus 100.

It is also to be noted that the sound reproducing devices may include an AV amplifier, and is not particularly limited. The sound reproducing device may include an audio amplifier equipped with a digital interface for audio and video such as an HDMI interface.

The embodiment is advantageous for a three-dimensional image reproducing apparatus provided with an interface for audio and video such as an HDMI interface.

What is claimed is:

1. A three-dimensional image reproducing apparatus comprising:
a data source unit operable to output stream data of 3D contents;
a data generating unit operable to output a 3D video signal of the 3D contents and an audio signal of the 3D contents on the basis of the stream data; and
a data transmission interface including a 2D video signal generating unit operable to generate a predetermined 2D video signal, the data transmission interface being operable to: receive the audio signal of the 3D contents; convert the audio signal of the 3D contents and the predetermined 2D video signal to a signal conforming to a 2D video transmission format; and
output the converted signal to an external device.

2. The three-dimensional image reproducing apparatus according to claim 1,
further comprising a controller operable to control the data transmission interface, and
wherein the data transmission interface receives both of the audio signal of the 3D contents and the 3D video signal of the 3D contents from the data generating unit; and
wherein, when the external device is an audio reproducing device not capable of receiving a signal conforming to a 3D video transmission format, the controller controls the data transmission interface so as to convert the audio signal of the 3D contents and the predetermined 2D video signal to the signal conforming to the 2D video transmission format and output the converted signal, and, when the external device is an device capable of receiving the signal conforming to the 3D video transmission format, the controller controls the data transmission interface so as to convert the audio signal of the 3D contents and the 3D video signal of the 3D contents to the signal conforming to the 3D video transmission format and output the converted signal.

3. The three-dimensional image reproducing apparatus according to claim 2,
wherein the data transmission interface includes:
a changeover circuit operable to receive the predetermined 2D video signal outputted from the 2D video signal generating unit and the 3D video signal outputted from the data generating unit, and selectively output either one of the predetermined 2D video signal and the 3D video signal; and
a combining circuit operable to: receive a signal outputted from the changeover circuit and the audio signal of the 3D contents outputted from the data generating unit; combine the audio signal of the 3D contents with the signal outputted from the changeover circuit; and output the combined signal.

4. The three-dimensional image reproducing apparatus according to claim 1,
wherein the predetermined 2D video signal includes a synchronization signal that can be used for 2D video display an image display device.

5. The three-dimensional image reproducing apparatus according to claim 1,
wherein the predetermined 2D video signal includes a video signal which is displayed as a black screen if an image display device performs a 2D image reproduction using the video signal.

6. The three-dimensional image reproducing apparatus according to claim 1,
wherein the data transmission interface is an HDMI interface.

7. A three-dimensional image reproducing method comprising:
outputting a 3D video signal of 3D contents and an audio signal of the 3D contents on the basis of stream data of the 3D contents;
generating a predetermined 2D video signal; and
converting the audio signal of the 3D contents and the predetermined 2D video signal to a signal conforming to a 2D video transmission format, and outputting the converted signal to an external device from a data transmission interface.
